(19) United States
(12) Patent Application Publication
(10) Pub. No.: US 2006/0044291 A1
(43) Pub. Date: Mar. 2, 2006

(54) Segmenting a waveform that drives a display

(76) Inventor: Thomas E. Willis, Mountain View, CA (US)

Correspondence Address: TROP PRUNER & HU, PC, 8554 KATY FREEWAY, SUITE 100, HOUSTON, TX, 77024, US

(21) Appl. No.: 10/926,373

(22) Filed: Aug. 25, 2004

(51) Int. Cl. G09G 5/00

(52) U.S. Cl. 345/204

(57) ABSTRACT

In one embodiment, the present invention includes a method of segmenting a refresh time of a waveform that drives a display element into a plurality of bundles, each of the bundles including a plurality of intervals; and transmitting first information corresponding to one of the plurality of intervals at which the waveform transitions state to a memory associated with the display element. The display element may be a pixel of a liquid crystal on silicon (LCOS) device.

### BACKGROUND

The present invention relates generally to displays, and more particularly, using pulse-width modulation to drive one or more display elements of an electro-optical display.

Pulse-width modulation (PWM) has been employed to drive liquid crystal (LC) displays. A pulse-width modulation scheme may control displays, including emissive and non-emissive displays, which may generally comprise multiple display elements. In order to control such displays, the current, voltage or any other physical parameter driving the display element may be manipulated. When appropriately driven, these display elements, such as pixels, normally develop light that can be perceived by viewers.

In an emissive display example, to drive a display (e.g., a display matrix having a set of pixels), electrical current is typically passed through selected pixels by applying a voltage to the corresponding rows and columns from drivers coupled to each row and column in some display architectures. An external controller circuit typically provides the necessary input power and data signal. The data signal is generally supplied to the column lines and is synchronized to the scanning of the row lines. When a particular row is selected, the column lines determine which pixels are lit. An output in the form of an image is thus displayed on the display by successively scanning through all the rows in a frame.

For instance, a spatial light modulator (SLM) uses an electric field to modulate the orientation of an LC material. By the selective modulation of the LC material, an electronic display may be produced. The orientation of the LC material affects the intensity of light going through the LC material. Therefore, by sandwiching the LC material between an electrode and a transparent top plate, the optical properties of the LC material may be modulated. In operation, by changing the voltage applied across the electrode and the transparent top plate, the LC material may produce different levels of intensity on the optical output, altering an image produced on a screen.

Typically, a SLM, such as a liquid crystal on silicon (LCOS) SLM, is a display device where a LC material is driven by circuitry located at each pixel. For example, when the LC material is driven, an analog pixel might represent the color value of the pixel with a voltage that is stored on a capacitor under the pixel. This voltage can then directly drive the LC material to produce different levels of intensity on the optical output. Digital pixel architectures store the value under the pixel in a digital fashion, e.g., via a memory device. In this case, it is not possible to directly drive the LC material with the digital information, i.e., there needs to be some conversion to an analog form that the LC material can use.

A PWM waveform may be generated from information stored in the memory device. Such information requires a particular amount of memory. The memory requirements create additional costs and increase complexity and size of a display.

Furthermore, for single-transition display architectures, where the on-time of a PWM waveform is continuous, pulse edges may appear at any point during the refresh time. This complicates data delivery to the modulation hardware in the device, as the SLM must provide some manner to allow information used to determine the state at a second time (e.g., time t+Δ) to arrive on the device while the SLM is updating its state for a first time (e.g., time t). Techniques such as double buffering are used to overcome these issues by allowing the SLM to load the second time information into one structure while simultaneously using another structure to provide the first time data. However, this technique requires additional memory and other circuitry. Accordingly, a need exists to perform PWM modulation using minimal memory in the display and to simplify digital modulation of the display.

### BRIEF DESCRIPTION OF THE DRAWINGS

FIG. 1 is a block diagram of a display device in accordance with one embodiment of the present invention.

FIG. 2 is a block diagram of a display controller and display array in accordance with one embodiment of the present invention.

FIG. 3 is a hypothetical graph of applied voltage versus time for a spatial light modulator (SLM) in accordance with one embodiment of the present invention.

FIG. 4 is a graphical representation of a refresh time in accordance with an embodiment of the present invention.

FIG. 5 is a flow diagram of a method in accordance with one embodiment of the present invention.

FIG. 6 is a graphical representation of two pixel waveforms in accordance with an embodiment of the present invention.

FIG. 7 is a block diagram of a signal generator in accordance with one embodiment of the present invention.

FIG. 8A is a hypothetical graphical representation of first and second pulse-width modulation (PWM) waveforms.

FIG. 8B is a hypothetical graphical representation of transformed waveforms in accordance with one embodiment of the present invention.

FIG. 8C is a hypothetical graphical representation of transformed waveforms in accordance with another embodiment of the present invention.

### DETAILED DESCRIPTION

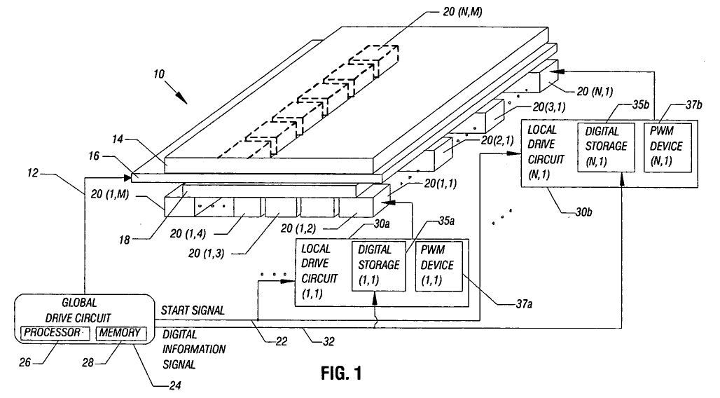

A display system 10 (e.g., a liquid crystal display (LCD), such as a spatial light modulator (SLM)) as shown in FIG. 1 includes a liquid crystal layer 18 according to an embodiment of the present invention. In one embodiment, the liquid crystal layer 18 may be sandwiched between a transparent top plate 16 and a plurality of pixel electrodes 20(1, 1) through 20(N, M), forming a pixel array comprising a plurality of display elements (e.g., pixels). In some embodiments, the top plate 16 may be made of a transparent conducting layer, such as indium tin oxide (ITO). Applying voltages across the liquid crystal layer 18 through the top plate 16 and the plurality of pixel electrodes 20(1, 1) through 20(N, M) enables driving of the liquid crystal layer 18 to produce different levels of intensity on the optical outputs at the plurality of display elements, i.e., pixels, allowing the display on the display system 10 to be altered. A glass layer 14 may be applied over the top plate 16. In one embodiment, the top plate 16 may be fabricated directly onto the glass layer 14.

A global drive circuit 24 may include a processor 26 to drive the display system 10 and a memory 28 storing digital information including global digital information indicative of a common reference and local digital information indicative of an optical output from at least one display element, i.e., pixel. In some embodiments, the global drive circuit 24 applies bias potentials 12 to the top plate 16. Additionally, the global drive circuit 24 may provide a start signal 22 and a digital information signal 32 to a plurality of local drive circuits (1, 1) 30a through (N, 1) 30b, each of which may be associated with a different display element being formed by the corresponding pixel electrode of the plurality of pixel electrodes 20(1, 1) through 20(N, 1), respectively.

In one embodiment, a LCOS technology may be used to form the display elements of the pixel array. Liquid crystal devices formed using the LCOS technology may form large screen projection displays or smaller displays (using direct viewing rather then projection technology). Typically, the LC material is suspended over a thin passivation layer. A glass plate with an ITO layer covers the liquid crystal, creating the liquid crystal unit sometimes called a cell. A silicon substrate may define a large number of pixels. Each pixel may include semiconductor transistor circuitry in one embodiment. However, in other embodiments other digital modulation schemes and devices, for example, a digital light processor (DLP), such as a microelectromechanical systems (MEMS) device (e.g., a digital micromirror device) may be used.

One technique in accordance with an embodiment of the present invention involves controllably driving the display system 10 using pulse-width modulation (PWM). More particularly, for driving the plurality of pixel electrodes 20(1,1) through 20(N, M), each display element may be coupled to a different local drive circuit of the plurality of local drive circuits (1, 1) 30a through (N, 1) 30b, as an example. To hold and/or store any digital information intended for a particular display element, a plurality of digital storage (1, 1) 35a through (N, 1) 35b may be provided, each of which may be associated with a different local drive circuit of the plurality of local drive circuits (1, 1) 30a through (N, 1) 30b, for example. As discussed further below, such digital information may be a minimum amount of information encoding a transition within a PWM waveform.

For generating a pulse-width modulated waveform based on the respective digital information, a plurality of PWM devices (1, 1) 37a through (N, 1) 37b may be provided in order to drive a corresponding display element. In one case, each PWM device of the plurality of PWM devices (1, 1) 37a through (N, 1) 37b may be associated with a different local drive circuit of the plurality of local drive circuits (1, 1) 30a through (N, 1) 30b.

Consistent with one embodiment of the present invention, the global drive circuit 24 may receive video data input and may scan the pixel array in a row-by-row manner to drive each pixel electrode of the plurality of pixel electrodes 20(1,1) through 20(N, M). Of course, the display system 10 may comprise any desired arrangement of one or more display elements. Examples of the display elements include spatial light modulator devices, emissive display elements, non-emissive display elements and current and/or voltage driven display elements.

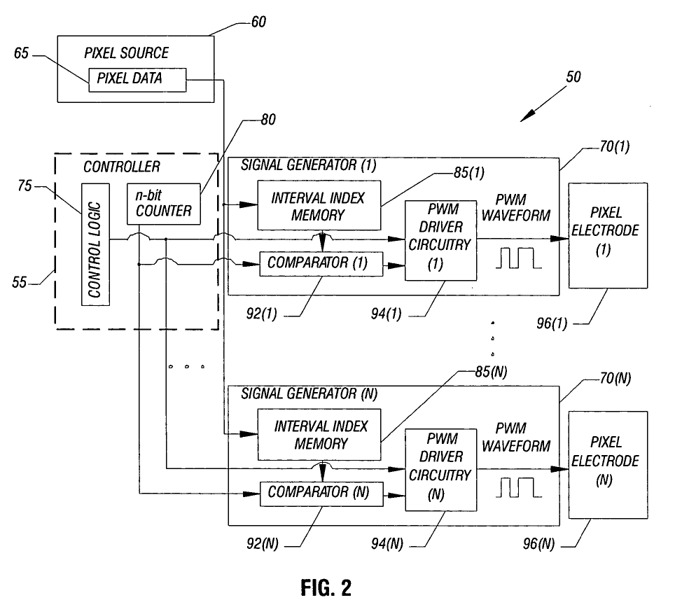

Following the general architecture of the display system 10 of FIG. 1, a SLM 50 shown in FIG. 2 includes a controller 55 to controllably operate SLM 50. For the purposes of storing digital information, SLM 50 may further include a pixel source 60. The pixel source 60 stores pixel data 65 comprising digital information that may include global digital information and local digital information in accordance with one embodiment of the present invention.

Although the scope of the present invention is not limited in this respect, pixel source 60 may be a computer system, graphics processor, digital versatile disk (DVD) player, and/or a high definition television (HDTV) tuner. In addition, pixel source 60 may not provide pixel data 65 for all of the pixels in the display system 10. For example, pixel source 60 may simply provide the pixels that have changed since the last update since in some embodiments having appropriate storage for all the pixel values, it will ideally know the last value provided by the pixel source 60.

SLM 50 may further comprise a plurality of signal generators 70(1) through 70(N), each associated with at least one display element. Each signal generator 70 may be operably coupled to controller 55 for receiving respective digital information. When appropriately initialized, each signal generator 70 may determine a transition in a PWM waveform based on the digital information to drive a different display element.

As shown in FIG. 2, in one embodiment, controller 55 may incorporate a control logic 75 and a counter 80 (e.g., n-bit wide). The control logic 75 may controllably operate each display element based on respective digital information. To this end, counter 80 may provide global digital information indicative of a dynamically changing common reference, i.e., a count, to each display element.

Pulse-width modulation may be utilized for generating color in an SLM device in an embodiment of the present invention. This enables pixel architectures that use pulse-width modulation to produce color in SLM devices. In this approach, the LC material may be driven by a signal waveform whose “ON” time is a function of the desired color value.

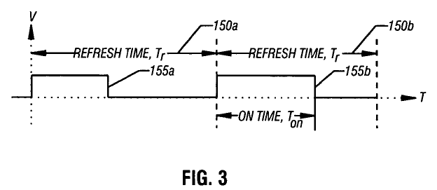

A hypothetical graph of an applied voltage versus time, i.e., a drive signal (e.g., a PWM waveform) is shown in FIG. 3 for a spatial light modulator in accordance with one embodiment of the present invention. Within a first refresh time period, Tᵣ, 150a, the drive signal includes a first transition 155a and during the next cycle, i.e., within a second refresh time period, Tᵣ, 150b, the drive signal includes a second transition 155b. The drive signal may be applied to pixel electrode 96(1) of FIG. 2, for example. Each transition of the first and second transitions 155a, 155b, separates the drive signal into a first and second pulse interval. The first pulse interval of the second refresh time period 150b is indicated as the “ON” time, Tₒₙ, as an example.

In some embodiments, the “ON” time, Tₒₙ, of the drive signal of FIG. 3 is a function, f_{pwm}, of the current pixel value, p, where pε[0, 2ⁿ−1], n is the number of bits in a color component (typically 8 for some computer systems), Tₒₙε[0, Tᵣ], and Tᵣ is a constant refresh time. For example, if f_{pwm}, is linear, then Tₒₙ may be given by the following equation:

$${T}_{on} = {f}_{pwm} ( p ) = \frac{p}{{2}^{n} - 1} {T}_{r} \qquad ( 1 )$$

The first and second refresh time periods, i.e., Tᵣ, 150a and 150b, may be determined depending upon the response time, i.e., Tᵣₑₛₚ, of the LC material along with an update rate, i.e., T_{update}, (e.g., the frame rate) of the content that the display system 10 (FIG. 1) may display when appropriately driven. Ideally, the refresh time periods, i.e., Tᵣ, 150a and 150b may be devised to be shorter than that of the update rate, T_{update}, of the content, and the minimum “ON” time (Tₒₙ), may be devised to be larger than the response time, Tᵣₑₛₚ, of the LC material. However, Tₒₙ may be time varying as a pixel value “p” may change over time.

To map transitions of the drive signal, i.e., a PWM waveform (such as that shown in FIG. 3), a display in accordance with an embodiment of the present invention may quantize the refresh time into a discrete number of intervals. In one such embodiment, the number of intervals may be equal to the number of distinct colors that the device can display. In such manner, a PWM waveform for a pixel of value p may change state at interval i. However, to support non-linearity, the refresh time may be quantized into more intervals than there are distinct colors, in other embodiments.

Given a display (e.g., display system 10 of FIG. 1) that supports 2ⁿ distinct colors, encoding the “ON” time, Tₒₙ, requires n bits per pixel (note that the encoding may depend only on the number of distinct colors, not on the amount of quantization that the device provides). With this encoding, a display may provide n bits of storage per pixel and make all transition decisions within a refresh time without external information.

Referring back to FIG. 2, in one embodiment, controller 55 may operate as follows. In step 1, control logic 75 may present a “start” signal (e.g., the start signal 22 of FIG. 1) to each PWM driver circuitry (N) 94, which may generate a corresponding PWM waveform for the attached pixel at each pixel electrode (N) 96. In step 2, each PWM driver circuitry (N) 94 in each pixel turns its output “ON” in response to the “start” signal.

The n-bit counter 80 (where “n” may be the number of intervals within a refresh period) may begin counting up from zero in step 3. In step 4, each pixel monitors the counter value using comparator circuit 92 (N) that compares two n-bit values, i.e., the counter “c” and an interval index corresponding to the interval, i, at which the PWM waveform transitions state, for equality. An interval index memory 85 (N) may hold the interval index for the pixel. When a pixel finds that the counter value “c” is equal to its interval index “i,” the PWM driver circuitry 94 (N) turns its output “OFF.” This process repeats in an iterative manner by repetitively going back to the step 1 based on a particular implementation.

By shortening the update horizon, i.e., the amount of time over which a display can make transition decisions without an external input, the amount of on-display memory may be reduced. For example, consider an embodiment of a display that supports 8 distinct colors and quantizes its refresh time into 16 intervals. Adjacent intervals may be aggregated into larger groups which may be referred to as “interval bundles.”

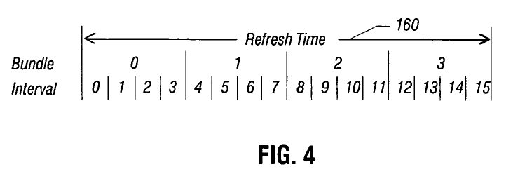

Referring now to FIG. 4, shown is a graphical representation of a refresh time in accordance with an embodiment of the present invention. As shown in FIG. 4, refresh time 160 is formed of a plurality of intervals. Specifically, as shown in FIG. 4, sixteen such intervals are present (i.e., numbered from interval 0 to interval 15), although the scope of the present invention is not so limited. That is, in other embodiments different numbers of intervals may be present. For example, in certain embodiments a refresh time may be quantized into 8 intervals, 32 intervals or some other number of intervals, as desired. FIG. 4 further shows that refresh time 160 is also segmented into a plurality of interval bundles, namely bundles 0 through 3. Each such bundle includes a plurality of individual intervals. In the embodiment shown in FIG. 4, each bundle includes four such intervals, although the scope of the present invention is not so limited.

In the example of FIG. 4, each interval bundle contains four intervals. Given 8 distinct colors, the display may provide 3 bits of storage per pixel, given the assumptions above. Of course, in other embodiments the storage size, number of colors, number of intervals, and bundle size may vary.

With this organization, the transition point for any possible PWM waveform may be encoded with a tuple that identifies: the bundle within the refresh time where the PWM waveform transition occurs; the interval within the bundle where the transition occurs (i.e., an interval index); and the new state of the waveform. Thus, coding the interval within a bundle uses lg n bits, where n is the number of intervals per bundle, l is the number of bundles, and g is the interval number. Note that as the number of bundles decreases, the amount of memory increases. For the example set forth above, n is 4 and thus the display may use 2 bits of storage per pixel. In such manner, the encoding for the PWM transition point may be decomposed into a portion consisting of the most significant bits (i.e., the bundle number) and the least significant bits (i.e., the interval index). However, in certain embodiments only the least significant bits may be stored on the display, thus reducing on-display memory requirements.

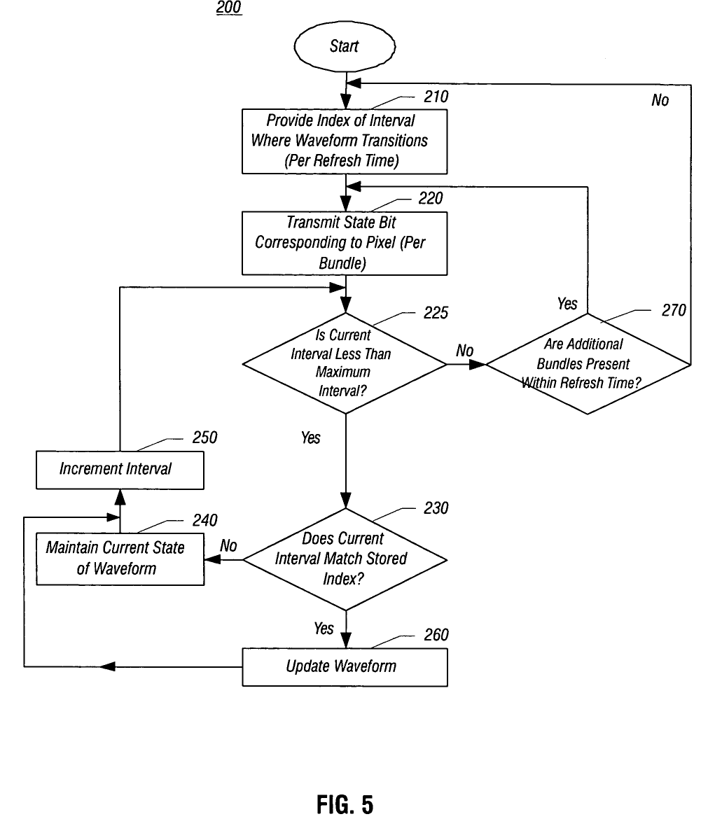

Referring now to FIG. 5, shown is a flow diagram of a method in accordance with one embodiment of the present invention. Specifically, method 200 may be used to provide digital information to a signal generator associated with a display element (i.e., a pixel) to form a PWM waveform in accordance with an embodiment of the present invention.

As shown in FIG. 5, an index of an interval where a waveform transitions may be provided to a signal generator (block 210). Such index may be provided once per refresh time and may be sent to the signal generator prior to the start of a given refresh time. In one embodiment, the index may be stored in an imager (i.e., on display) memory associated with the signal generator. The index may correspond to an index of the interval within a bundle at which the waveform for a given display element (e.g., pixel) transitions state. Next, a state bit corresponding to the pixel may be transmitted (block 220). An independent state bit may be associated with each bundle of a refresh time. Accordingly, such a state bit may be sent once per bundle and preferably prior to the start of each bundle. In certain embodiments, the state bit for a given pixel may be zero if the waveform transitions to zero and one if the waveform transitions to a one at the interval index stored in block 210.

Next, it may be determined whether the current interval is less than the maximum interval (diamond 225). For example, in an embodiment in which each bundle includes four intervals, the maximum interval is four. While the current interval is less than the maximum interval, it may be determined whether it matches the stored index (diamond 230). For example, an interval counter may be used to count the number of intervals per bundle. In an embodiment having four intervals per bundle, the interval counter may count from 0 to 3, for example. If the current interval does not match the stored index, the waveform may maintain its current state (block 240) and the interval may be incremented, for example, by incrementing the interval counter (block 250). Then control returns to diamond 225.

If instead at diamond 230 it is determined that the current interval matches the stored index, the waveform may be updated (block 260). Specifically, the waveform may be updated by transitioning states, depending on the value of the state bit. For example, if the previous bundle had a state bit of zero and the current bundle has a state bit of zero, there is no transition and the state of the waveform is maintained. In contrast, if the current bundle has a state bit different than that of the previous bundle, the waveform may transition to the new state. In certain embodiments, the waveform may be toggled if the state bit for a pixel is at a logic high level and the current interval matches the stored interval index for the pixel, although the scope of the present invention is not so limited. Then, control may pass to block 250 to increment the interval.

When it is determined at diamond 225 that the current interval is not less than the maximum, control passes to diamond 270. There it may be determined whether additional bundles are present within the refresh time (diamond 270). If so, control may return to block 220 for further processing. Alternately, if no further bundles are present in the refresh time, control may pass back to block 210 for resumption of method 200 for a next refresh time.

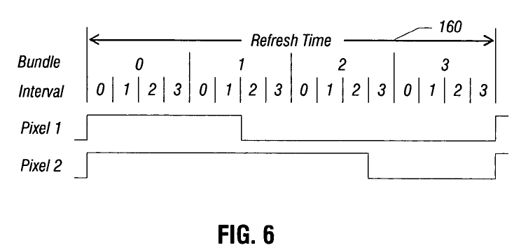

Referring now to FIG. 6, shown is a graphical representation of two pixel waveforms in accordance with an embodiment of the present invention. As shown in FIG. 6, these pixel waveforms are illustrated within a refresh time 160 having a plurality of bundles, each of which includes a plurality of individual intervals. Note that in this example, the intervals are numbered sequentially within each bundle, rather than sequentially within the entire refresh time as set forth in FIG. 4.

As shown in FIG. 6, for pixel 1, the interval index is “2” (since the waveform transitions at the start of interval 2 of bundle 1) and the state bit is “1” for bundles 0 and “0” for bundles 1, 2, and 3. For pixel 2, the interval index is “3” (since the waveform transitions at the start of interval 3 within bundle 2) and the state bit is “1” for bundles 0 and 1, and “0” for bundles 2 and 3.

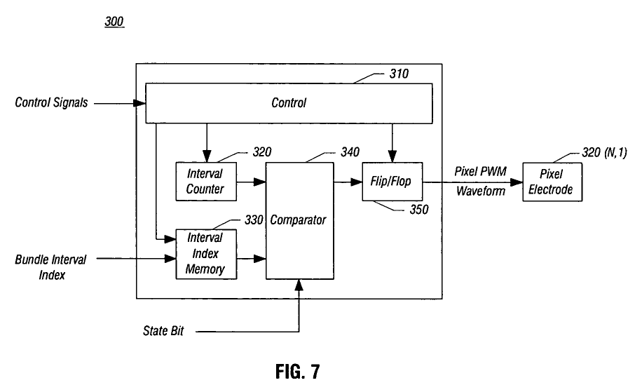

Referring now to FIG. 7, shown is a block diagram of a signal generator in accordance with one embodiment of the present invention. As shown in FIG. 7, signal generator 300 may be used to generate PWM waveforms in accordance with an embodiment of the present invention. As shown in FIG. 7, signal generator 300 may be physically coupled to a pixel electrode 320 (N,1) that is used to activate an associated display element (i.e., pixel). Accordingly, signal generator 300 may be physically part of a display device, such as a LCOS SLM.

As shown in FIG. 7, signal generator 300 may include a control block 310 that receives external control signals from an associated display controller or other such device. In turn, control block 310 provides control signals to an interval counter 320 and a storage element 350 (e.g., a flip-flop, such as a D-type flip-flop). Interval counter 320 may be used to count intervals within the bundles of the refresh time, and may output such counts to a comparator 340, which may compare the current interval count to a value stored in an interval index memory 330. More specifically, memory 330 may store an interval index received from the display controller which corresponds to the interval within a bundle at which the PWM waveform is to transition states. Furthermore, as shown in FIG. 7, memory 330 may receive control signals from control block 310.

Comparator 340 may compare a value received from interval counter 320 to the value stored in memory 330. If these values match, comparator 340 may provide the value of an external state bit, received at an input of comparator 340, to storage element 350. The external state bit may correspond to the value to which the waveform is to be transitioned. Then, storage element 350 may output its value, which may be converted to the pixel PWM waveform that is provided to a pixel electrode 320 (N,1). While not shown in FIG. 7, it is to be understood that PWM driver circuitry may be present to convert the output of storage element 350 into the PWM waveform.

Thus, in various embodiments, control block 310 may generate timing and appropriate sequencing for events within signal generator 300. Interval counter 320 may count the intervals within each bundle. For example, to implement counting in an embodiment having 4 intervals per bundle, counter 320 may count from 0 to 3. Index memory 330 may store the interval index for the current refresh time (for example, the value “3” for Pixel 2 in FIG. 6). Comparator 340 may compare the values received from interval counter 320 and interval index memory 330 and either hold the state of flip-flop 350 (if the current interval is not equal to the interval index) or load the value from the external state bit (if the current interval is equal to the interval index).

While the embodiment of FIG. 7 shows the data path for a single pixel, in other embodiments, a signal generator may be extended to handle multiple pixels. That is, while the embodiment of FIG. 7 shows all components of signal generator 300 associated with a single display element, in other embodiments, some of the components may be associated with a plurality of display elements. Furthermore, these components need not be physically coupled to a display element. For example, an interval index memory need not be physically coupled to associated display elements. Instead, a common or global interval index memory such as an external dynamic random access memory (DRAM) or other such memory device may be separately coupled to a plurality of display elements. Similarly, in certain embodiments control block 310, interval counter 320 and comparator 340 may be global components shared by a plurality of display elements.

In another embodiment, signal generator 300 may be modified such that it includes a lookup table (LUT) or other such programmable storage device to perform modulo operations on an input number. For example, a count value corresponding to a location within a refresh time at which the PWM waveform is to transition may be input and a modulo operation may be performed. A result of the operation may include a remainder portion that identifies the interval index at which the waveform is to transition, while the non-remainder portion of the result provides the identification of the bundle during which the transition is to occur.

In various embodiments, a fully-functional memory is not needed for the memory that stores the interval index (e.g., interval index memory 330 of FIG. 7). That is, if this memory fails, the maximum error in a PWM waveform is bounded by the duration of a bundle. In other words, the enable bit (i.e., the state bit) will ensure a transition occurs, although it may not occur at the right point within the bundle, depending on the failure mode of the memory that stores the interval index. By balancing the bundle duration with the maximum tolerable error in a PWM transition, repair or redundancy schemes in the interval index memory may be eliminated, thus providing a substantial design savings.

In such manner, embodiments of the present invention may reduce the amount of on-display memory needed to implement digital modulation. In addition, inherent fault-tolerance is provided. If the memory that holds the interval index fails, the maximum error that can occur within the PWM waveform is given by the ratio of the duration of a bundle to the duration of a refresh time. If the bundle is below a critical size, there is no need to provide repair or redundancy in the interval index memory (since the maximum error that could arise is less than the required tolerance of the PWM transition times), greatly simplifying implementation.

In various embodiments, transitions of a PWM waveform may be remapped within a refresh time. In such manner, there is no possible collision between data delivery and usage, as delivery and use happen at distinct points in time. That is, during a first portion of a refresh time, digital information may be sent to a display (e.g., signal generator 300 of FIG. 7). Such data may then be used in a second portion of the refresh time and drive a PWM waveform.

There may be numerous transformations made to a PWM waveform to prevent such collisions. In certain embodiments, such transformations to a waveform may be performed while using the interval mapping structure and methods discussed above, while in other embodiments transformations may be performed independently of such interval mapping.

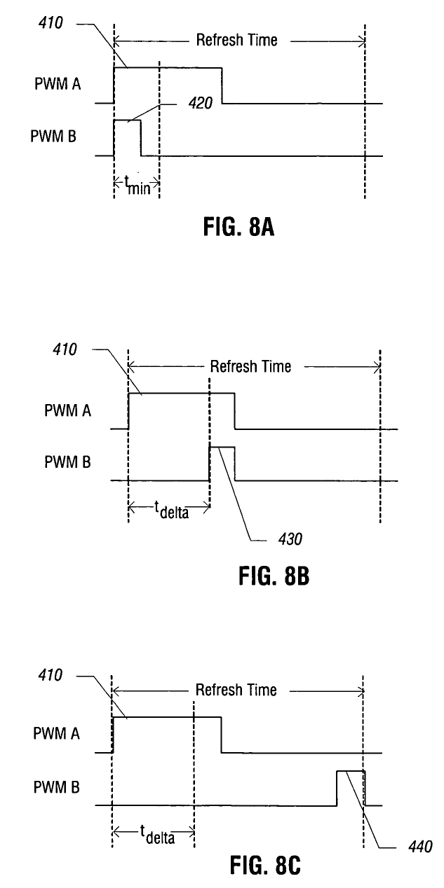

Referring now to FIG. 8A, shown is a hypothetical graphical illustration of first and second PWM waveforms. As shown in FIG. 8A, a first waveform (i.e., PWM A) has an “ON” time 410 that is greater than a minimum pulse threshold (i.e., tₘᵢₙ). However, the second waveform shown in FIG. 8A (i.e., PWM B) has an “ON” time 420 that is less than tₘᵢₙ. In various embodiments, waveforms having an “ON” time less than the minimum pulse threshold may be delayed by a delay time. Such a delay time may correspond to a predetermined portion of a refresh time. With reference to FIG. 8A, all pulses with an “ON” time less than a minimum pulse threshold (tₘᵢₙ) are delayed by a delay time (t_{delta}, as shown in FIG. 8B).

Referring now to FIG. 8B, shown is a hypothetical graphical representation of transformed waveforms corresponding to the first and second waveforms of FIG. 8A. More specifically, as shown in FIG. 8B, first waveform PWM A does not change, as its “ON” time 410 is greater than the minimum pulse threshold. In contrast however, second waveform PWM B is delayed by t_{delta}, as its “ON” time 430 is less than the minimum pulse threshold. In such manner, there are now no transitions during a first portion of the refresh time, and the SLM is free to load data with no collision with the use of the data. In certain embodiments, the first portion may correspond to the delay time. In various embodiments, the delay time (i.e., t_{delta}) may be at least as great as the minimum pulse threshold (i.e., tₘᵢₙ) and at most one-half of the refresh time. Pulses with “ON” times larger than tₘᵢₙ (e.g., PWM A) are not delayed at all in certain embodiments.

In other embodiments, more complex transformations such as pulse flipping may be performed. In an embodiment in which pulse flipping is implemented, the original waveforms shown in FIG. 8A may be transformed into the waveforms shown in FIG. 8C. As shown in FIG. 8C, first waveform PWM A of FIG. 8C is the same as the original PWM A waveform of FIG. 8A, and has the same “ON” time 410. However, as shown in FIG. 8C, transformed waveform PWM B has its “ON” time 440 delayed. More specifically, PWM B waveform of FIG. 8C has its on pulse flipped and anchored to the opposite end of the refresh time (e.g., the short pulse may be transformed such that it appears at the end of the refresh time).

In the embodiments shown in FIGS. 8B and 8C, the SLM may update internal device state during a first portion corresponding to t_{delta} without data collision. Coupled with processing of streaming information, modulation data may more efficiently be presented to the device.

By transforming a pulse of a PWM waveform in time, more efficient hardware designs may be implemented that do not require the complexity of simultaneously handling writing of incoming modulation data and reading of current modulation data. In such manner, less expensive designs may be realized with lower complexity and faster time to market.

In one embodiment, signal generator 300 of FIG. 7 may be used to perform the transformations to the waveforms shown in FIGS. 8B and 8C. However, it is to be understood that the scope of the present invention is not so limited, and in other embodiments, different mechanisms (e.g., in hardware or software) may be used to perform such waveform transformations.

For example, embodiments may be implemented in a computer program that may be stored on a storage medium having instructions to program a display system to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device.

In one embodiment to perform pulse transformations, logic may be present to determine whether such a transformation is needed. For example, a bundle identification and interval index where a transition is to occur may be provided as inputs to the logic. The logic may then determine whether the transition would occur within a first portion or a second portion of the PWM waveform, where the first portion may be equal to a delay time. If the transition would occur in the first portion, the logic may provide a signal to delay the on pulse until the second portion of the waveform. In another such embodiment, if the waveform transitions in a first portion of a refresh time, the interval index and bundle identification may be used to subtract the on pulse from the total length of the refresh time. In such manner, the on pulse may be delayed and flipped to begin within the second portion of the refresh time and to terminate at the end of the refresh time.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
segmenting a refresh time of a waveform that drives a display element into a plurality of bundles, each of the bundles including a plurality of intervals; and
transmitting first information corresponding to one of the plurality of intervals at which the waveform transitions state, to a memory associated with the display element.

2. The method of claim 1, further comprising transmitting the first information before initiation of the refresh time.

3. The method of claim 1, further comprising transmitting second information corresponding to the state of the waveform for a given bundle.

4. The method of claim 3, further comprising transmitting the second information before initiation of the given bundle.

5. The method of claim 3, further comprising transmitting the second information for each of the plurality of bundles.

6. The method of claim 3, further comprising determining whether to transition the state based on the first information and the second information.

7. A method comprising:
delaying a pulse of a waveform that drives a display element if the pulse is less than a pulse threshold.

8. The method of claim 7, wherein the pulse threshold is less than half of a refresh time of the waveform.

9. The method of claim 7, further comprising delaying the pulse by a predetermined time.

10. The method of claim 9, wherein the predetermined time is greater than the pulse threshold and less than half of a refresh time of a waveform.

11. The method of claim 7, further comprising not delaying the pulse if the pulse is greater than the pulse threshold.

12. The method of claim 7, further comprising delaying the pulse by flipping the pulse such that the pulse ends at an end of a refresh time of the waveform.

13. A method comprising:
receiving an interval index corresponding to an interval within a refresh time of a waveform at which the waveform transitions state;
determining when the interval occurs during the waveform; and
transitioning the state of the waveform when the interval occurs.

14. The method of claim 13, wherein the interval is within one of a plurality of bundles, each of the plurality of bundles having a plurality of intervals.

15. The method of claim 14, further comprising receiving state information corresponding to a state of the waveform for each of the plurality of bundles.

16. The method of claim 13, further comprising storing the interval index in a memory associated with a display element, the display element being driven by the waveform.

17. The method of claim 13, wherein determining when the interval occurs comprises comparing the interval index to a count value.

18. An apparatus comprising:
a memory to store an interval index corresponding to an interval within a refresh time of a waveform at which the waveform transitions state; and
a display element coupled to the memory.

19. The apparatus of claim 18, further comprising a comparator coupled to the memory to determine when the interval occurs, the comparator to output a state signal corresponding to the state of waveform at the interval.

20. The apparatus of claim 19, further comprising a storage element coupled to receive the state signal.

21. The apparatus of claim 18, wherein the interval is within one of a plurality of bundles, each of the plurality of bundles having a plurality of intervals.

22. The apparatus of claim 21, wherein the memory comprises n bits, wherein a number of the plurality of intervals within one of the plurality of bundles is less than or equal to 2ⁿ.

23. The apparatus of claim 18, wherein the memory and the display element are physically coupled in a display device.

24. The apparatus of claim 23, further comprising a second memory coupled to the display device to store state information corresponding to the state of the waveform at a plurality of bundles of the refresh period.

25. The apparatus of claim 24, further comprising a display controller housing the second memory.

26. The apparatus of claim 18, wherein the memory comprises a non-redundant architecture.

27. An article comprising a machine-accessible storage medium containing instructions that if executed enable a system to:
provide an interval index corresponding to an interval within a refresh period of a waveform at which the waveform transitions state; and
provide a state value corresponding to the state of the waveform for each of a plurality of bundles of the refresh period.

28. The article of claim 27, further comprising instructions that if executed enable the system to provide the interval index to a memory associated with a display element.

29. The article of claim 27, further comprising instructions that if executed enable the system to provide the state value to a comparator associated with a display element.

30. The article of claim 27, further comprising instructions that if executed enable the system to store the interval index and the state value in a memory associated with a controller.

31. The article of claim 27, further comprising instructions that if executed enable the system to provide an identification of the one of the plurality of bundles in which the state of the waveform transitions.

32. A system comprising:
a spatial light modulator having at least one pixel;
a controller to send an interval index to the at least one pixel, the interval index corresponding to an interval within a refresh period of a waveform at which the waveform transition state; and
a memory to store the interval index, the memory associated with the at least one pixel.

33. The system of claim 32, further comprising a comparator coupled to the memory to determine when the interval occurs, the comparator to output a state signal corresponding to the state of waveform at the interval.

34. The system of claim 32, wherein the memory comprises a non-redundant architecture.

35. The system of claim 32, wherein the controller is coupled to provide a state value corresponding to the state of the waveform for each of a plurality of bundles of the refresh period.

36. The system of claim 35, wherein the controller is coupled to provide an identification of the one of the plurality of bundles in which the state of the waveform transitions.

37. The system of claim 32, wherein the system comprises a liquid crystal on silicon device.
